(19) United States
(12) Patent Application Publication
(10) Pub. No.: US 2009/0281940 A1
(43) Pub. Date: Nov. 12, 2009

(54) MICROBIAL ESTATES FOR THE EFFICIENT DEVELOPMENT AND MANAGEMENT OF BIOGENIC FUEL RESOURCES

(75) Inventors: James B. Dodson, Castle Rock, CO (US); Robert S. Pfeiffer, Parker, CO (US); Eric L. Szaloczi, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LUCA Technologies, Inc., Golden, CO (US)

(21) Appl. No.: 12/504,853

(22) Filed: Jul. 17, 2009

Related U.S. Application Data
(62) Division of application No. 11/211,180, filed on Aug. 23, 2005.

(51) Int. Cl. G06Q 40/00; G06Q 50/00

(52) U.S. Cl. 705/37

(57) ABSTRACT

A method of transferring an interest in microbial rights associated with a parcel of land. The method includes recognizing a microbial estate that includes the microbial rights, where ownership interests in the microbial estate are separately transferable from other estates associated with the parcel of land, and transferring one or more of the microbial rights of the microbial estate to a party that is not in possession or ownership of the microbial estate. Also, a method of searching interests in a microbial estate, where the method may include identifying a location for a parcel of land associated with the microbial estate, searching records associated with the identified parcel of land, and identifying in the records a name of one or more parties having an interest in the microbial estate. Methods of auctioning a microbial right in microbial property are also described.

### CROSS-REFERENCE TO RELATED APPLICATION

This application is a divisional of U.S. patent application Ser. No. 11/211,180, entitled “MICROBIAL ESTATES FOR THE EFFICIENT DEVELOPMENT AND MANAGEMENT OF BIOGENIC FUEL RESOURCES,” filed Aug. 23, 2005 by James B. Dodson et al, the entire disclosure of which is incorporated herein by reference for all purposes.

### BACKGROUND OF THE INVENTION

In the United States, theories of ownership rights in real property have evolved to conceptualize land as a bundle of rights that may be separately leased or sold to different stakeholders. For example, the property may be divided into separate estates for surface rights, water rights, mineral rights, and oil and gas rights. Each of these estates may be leased or sold to different parties who value one or more of the estates more than the remaining estates. A homeowner, for example, places a high value on the surface rights estate that gives the estate owner the exclusive right to build a house or other building on the land. An oil and gas company places premium value on owning or leasing an oil and gas estate that entitles the company to recover oil and gas from the subsurface regions of the land. A mining company is primarily interested in the mineral rights estate that entitles the company to recover minerals and metals from the land.

By conceptualizing land as having separately alienable estates, a party can negotiate or bid for the right, or subset of rights, they value most while allowing other parties to negotiate or bid on the estates they value most. This division and transfer of separate estates furthers an economic goal of putting the land to its most economically valuable uses by transferring interests to those who can realize the most economic value from each estate. In contrast, if the land was not divided into separate estates, a landowner whose interests focused on one or a small subset of land uses would not realize any economic gain from the remaining estates.

New estates in land can arise when new economic uses for the land are developed or discovered. For example, the widespread recognition of an oil and gas estate in land did not arise until after the discovery of subterranean oil deposits in Pennsylvania in the mid-1800s. More recently, scientific and technological discoveries have indicated the feasibility of commercial production of fuel gases such as methane from the metabolic processes of microorganisms (i.e., biogenic fuel production). Most of the microorganism species being investigated have been extracted from native environments in geologic formations. New methods of commercial scale biogenic fuel production are also being developed.

Research is revealing some of the most promising biogenic fuel production technology involves the growth and stimulation of native microorganism populations in an underground formation environment. These native populations are threatened in several instances by commercial oil and gas recovery methods that involve the removal of produced water from the geologic formation in which biogenic gas has been located. For example, in the Powder River Basin in Wyoming, approximately 44 million barrels of water, estimated to contain on the order of 100,000,000,000,000,000,000 native microorganisms, is being pumped each month from coal seams and disposed of on the surface where oxygen destroys the anaerobic microorganisms. Without a market for biogenic fuel production that can set a value for the native microorganisms, there is little chance of showing that the destruction of these microorganisms is causing significant and irreversible economic waste. Populations of slowly replicating microorganisms could take decades to recover from this destruction, and there is a strong possibility that several species of promising microorganisms could be irrevocably depleted if no effort is made to preserve at least part of their ecosystems. Thus, there is a need for the law to recognize a microbial estate in land. These and other issues are addressed by embodiments of the present invention.

### BRIEF SUMMARY OF THE INVENTION

Embodiments of the invention include methods of auctioning microbial rights in microbial property. The methods may include the steps of posting, on an electronic trading system, an offer for a proprietary interest in the microbial right, and soliciting one or more bids for the microbial right from bidders accessing the electronic trading system, where the bidder having a highest bid price acquires the proprietary interest in the microbial right.

Embodiments of the invention also include methods of purchasing, conveying, transferring, leasing or renting interests in microbial rights associated with parcel of land. The methods may include the step of defining a microbial estate comprising the microbial rights, where ownership interests in the microbial estate are separately transferable from other estates associated with the parcel of land, and transferring, leasing or renting one or more of the microbial rights of the microbial estate to a party that is not in possession or ownership of the microbial estate.

Embodiments of the invention may further include systems for searching ownership interests in microbial estates. The systems may include a database having a real estate table that relates a location of real estate to one or more microbial rights of the microbial estate associated with the real estate, and an ownership table that relates an owner with at least one of the microbial rights.

Embodiments of the invention still further include methods of searching interests in microbial estates. The methods may include the steps of identifying a location for a parcel of land associated with the microbial estate, searching in a title office records associated with the identified parcel of land, and identifying in the records a name of one or more parties having an interest in the microbial estate.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIG. 1 is a flowchart outlining the steps in a method of recognizing and transacting in a microbial estate according to embodiments of the invention;

FIG. 2 shows a database structure for searching and listing microbial rights and parties that hold interests in the rights according to embodiments of the invention;

FIG. 3 shows a system for searching and listing interests in microbial estates according to embodiments of the invention;

FIG. 4 is a flowchart with showing tasks performed by landmen to determine the parties holding interests in a microbial estate according to embodiments of the invention;

FIGS. 5A-B show a flowchart that outlines steps in a method of auctioning microbial rights according to embodiments of the invention; and

FIG. 6 shows an electronic auction network that may be used to implement electronically a microbial rights auction according to embodiments of the invention.

### DETAILED DESCRIPTION OF THE INVENTION

The present invention includes the recognition of a microbial estate in a parcel of land that may be separately conveyed, leased, sub-leased, transferred, rented, assigned, etc., from other rights and estates in the property. The recognition and alienability of a separate microbial estate in real property facilitates the formation of a market in microbial rights that will help allocate interests in those rights to the parties that are able to realize the highest economic value from those interests. For example, a microbial estate may include the right to collect microorganisms found on the land, which may be used to enhance the biogenic production of hydrocarbons (e.g., methane) from carbonaceous deposits on the property or an off-site carbonaceous formation. The owner of the microbial estate may auction off a leasehold in this microorganism collection right to the highest bidder having an interest in collecting microorganisms from the land. In another example, the microbial estate owner may lease or assign a right to remove and own microorganisms, and/or ferae naturae owned upon reduction to possession, found within the boundaries of the land. The microbial estate may also establish who has ownership and control over the microorganisms found in-situ on a parcel of land, where the microorganisms may be treated as part of the real property of the parcel, or as personal property.

The recognition and transactions of a microbial estate can give parties the option to use already established principles and procedures of property law to conduct the transactions, including procedures for transfer of title to real property and recording interests in real property. Furthermore, in situations where the microbial estate and another estate may encroach on one another, parties may rely on settled principles of property law to guide the resolution of these disputes as well. Alternatively, parties may resolve questions about the scope and transfer of rights in the microbial estate using principles of contract law recognized and/or established in the appropriate jurisdiction.

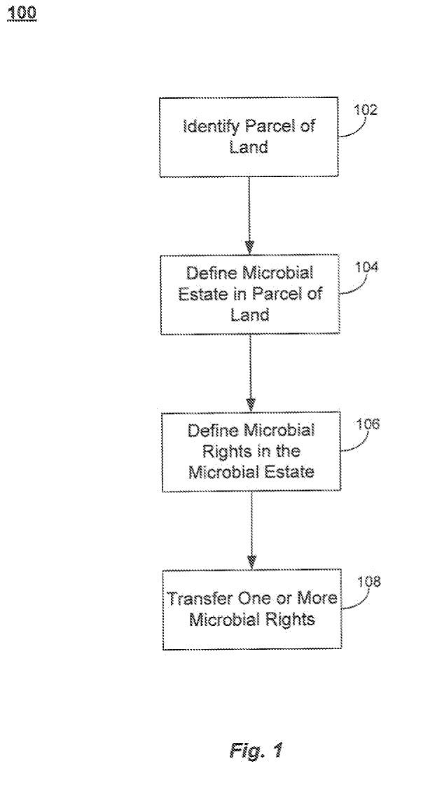

FIG. 1 outlines steps in a method 100 of creating and transacting in a microbial estate according to embodiments of the invention. The method 100 includes identifying one or more parcels of land 102 in which the microbial estate will be created. The estate may originate from a previously recognized estate (or estates) in the parcel, such as the estate encompassing the surface rights in the parcel, the water rights, the mineral rights, the oil and gas rights, etc. For example, the microbial estate may be recognized in the estate or rights held by the surface owner. In another example, the microbial estate may be recognized in separate water, mineral, and/or oil and gas estates that were previously separated from the remaining estates in the parcel. Alternatively, the microbial estate may originate from a subset of less than all the estates in the parcel (e.g., a single estate) and its conveyance, encumbrance, or sale only requires the consent of the party or parties having an interest in the originating estates.

The microbial estate may be defined 104 in a number of ways, such as by defining one or more microbial rights 106 that are part of the estate. For example, the estate may be defined by the right to possess and own and/or sell microorganisms that are captured on the parcel. The right may be defined broadly to encompass all microorganisms the rights holder can capture on the property, or it may be defined to encompass all, or a subset of less than all the microorganisms present within the boundaries of the parcel. Microorganism subsets may be defined as a single species, a group of species, a single genus, a group of genera, etc. The microorganism subsets may also be defined based on the physical location or environmental conditions where the microorganisms are found. For example, the microbial estate may be defined to include a right to possess, own, and/or sell the microorganisms located in a specified geological formation on the parcel of land. The estate may also include a microbial right to take microorganisms removed from the parcel and introduce them on a different parcel.

Another example of a microbial right that may be part of the microbial estate is the right to enter the parcel and stimulate the growth and dispersion of microorganisms within a formation on the parcel. This right may include the right to gain access to subterranean formations on the parcel through digging, drilling, etc. and supply water, nutrients, microorganisms, etc., to the formation in order to stimulate growth. Similar to the rights to capture and/or own microorganisms on the parcel, the right to stimulate growth of microorganisms may be broadly defined to encompass all locations within the physical boundaries of the parcel, or more narrowly defined to particular sites, depths, and locations on the parcel. Microbial rights may further include the right to introduce additional microorganisms to the parcel, including non-native and/or anthropometrically engineered microorganisms.

One or more of the microbial rights in the microbial estate, or the microbial estate as a whole, may be transferred to a buyer, lessee, sub-lessee, etc. 108. Transfers of microbial rights include the outright sale or assignment of the microbial estate, and leases of the estate for a term of years, or a defeasible term. Transfers may also include a sub-lease by the lessee for a term shorter than the original lease (e.g., for the remainder of the lease period). Transfers may still further include a sub-lease or sub-assignment of less than the whole microbial estate or right acquired by the transferee. For example, a transfer may include a transfer from an assignee to a sub-assignee of a right to stimulate biogenic methane production that is limited to a particular site on the parcel, where the assignee still holds the right to stimulate biogenic methane production at all other locations of the parcel.

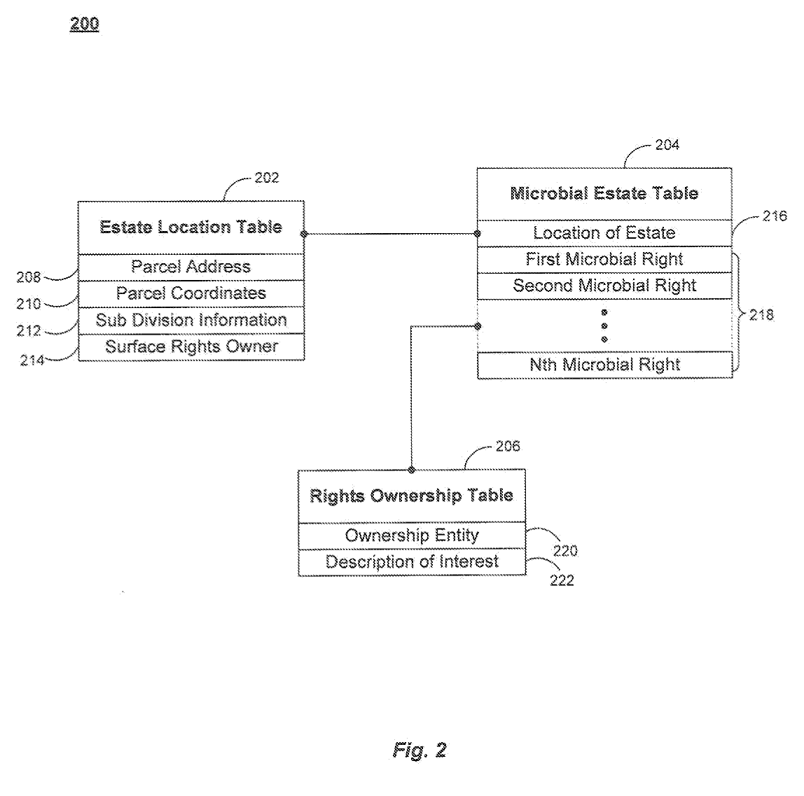

Because the microbial estate may not be simply defined by the physical borders of the parcel of land, a need can quickly arise for a system to give buyers and lessees reliable notice of the parties that hold interests in the microbial estate. FIG. 2 shows a database structure 200 for searching and recording microbial rights and parties that hold interests in the rights according to embodiments of the invention. In the embodiment shown, the database organization includes a microbial estate location table 202, a microbial estate table 204, and a rights ownership table 206.

The estate location table 202 may include fields for identifying the location of a microbial estate using a postal address 208 of the parcel of land associated with the microbial estate. Location table 202 may also include fields for identifying the parcel of land by map coordinates 210 (e.g., GPS coordinates) or legal description. Field 210 may be particularly useful when a postal address is not available to accurately describe the physical location and boundaries of the parcel. Location table 202 may also include fields for identifying sub-divisions of a parcel 212. This field 212 may include map coordinates for the boundaries of the sub-division, and/or name and descriptions of geologic formations on the parcel. This field 212 may be particularly useful for microbial estates located on large parcels of land and parcels having multiple formations of interest for biogenic hydrocarbon production. Location table 202 may also include a surface rights owner field 214 that identifies the entity or entities (e.g., person, trust, partnership, organization, corporation, government entity, etc.) that hold ownership and/or leasehold interests in the surface rights of the identified parcel.

The microbial estate table 204 may be linked to the estate location table 202 to associate a parcel of land with the details of the microbial estate for the parcel. The microbial estate table 204 may include a location field 216 for associating the microbial rights that make up the microbial estate with a parcel location. The microbial estate table 204 also includes fields for the defined microbial rights 218 of the estate. These microbial rights may include, for example a first microbial right for capture of microorganisms on the parcel, a second microbial right for stimulation of biogenic hydrocarbon production on the parcel, etc. The number of microbial rights may vary from one microbial estate to the next being described in microbial estate table 204. The table 204 can also be edited to add, delete or change the description of a microbial right 218 associated with one or more of the microbial estates.

The rights ownership table 206 may be linked to the microbial estate table 204 to associate the microbial rights fields 218 with the parties that have interests in those rights. For example, each of the microbial rights fields 218 for each microbial estate may be associated with fields in the ownership rights table 206 that identify the parties having an interest in each of the rights. The rights ownership table 206 may include the identity of the entity 220 having an interest in one or more of the microbial rights 218 in a microbial estate. The identity information may include contact information for the entity, such as a postal address, telephone number, facsimile number, email address, website address, etc. Table 206 may also include a description of the interest 222 the ownership entity has in the microbial right listed in field 218. For example, the description of interest field 222 may show that the entity owns the microbial right, has a lease in the microbial right for a term of years, has a mortgage lien on the microbial right, etc. The description of interest field 222 may also include covenants and other restrictions that would affect the microbial estate associated with the identified parcel.

The database structure 200 may be designed to be searchable through fields in all of the tables. A search may start with the legal description, address and/or map coordinates of a parcel of land in that looks at whether a separate microbial estate has been created for the parcel, what microbial rights are defined for that estate, and what parties hold interests in those rights and/or the estate as a whole. In addition, the search may start with the identity of an entity (e.g., person, business, partnership, joint venture, etc.) suspected of holding interests in microbial estates. This search can identify the microbial rights and estates on identified parcels of land in which the entity has a recorded interest. Searches may also be conducted to identify all parcels that have a particular kind of microbial right in the microbial estate. The search results may include the identity of the parcels, as well as the identity of the entities that have recorded interests in the right.

Searches may also be conducted to alert the searcher when a temporary interest in a microbial right (e.g., a lease) is set to expire. Searches may also be conducted to identify or search the microbial estates associated with parcels located in a defined geographic region.

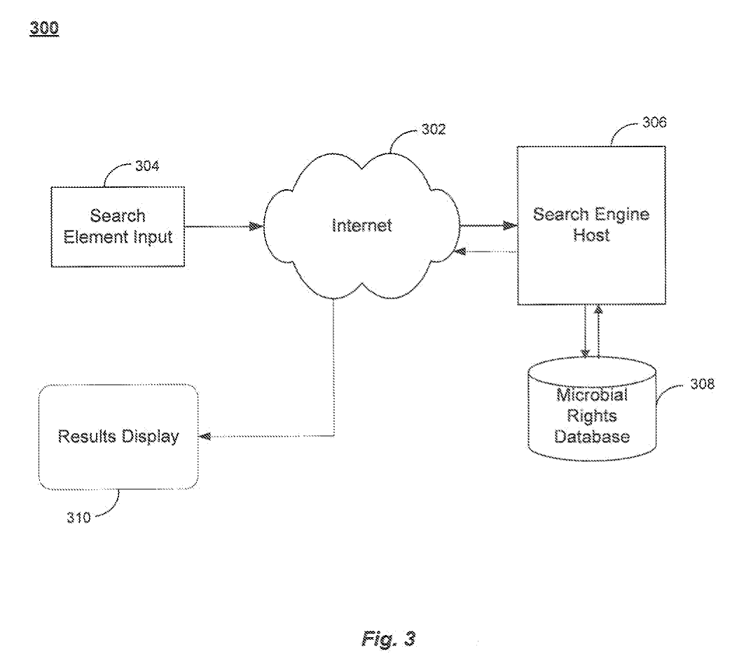

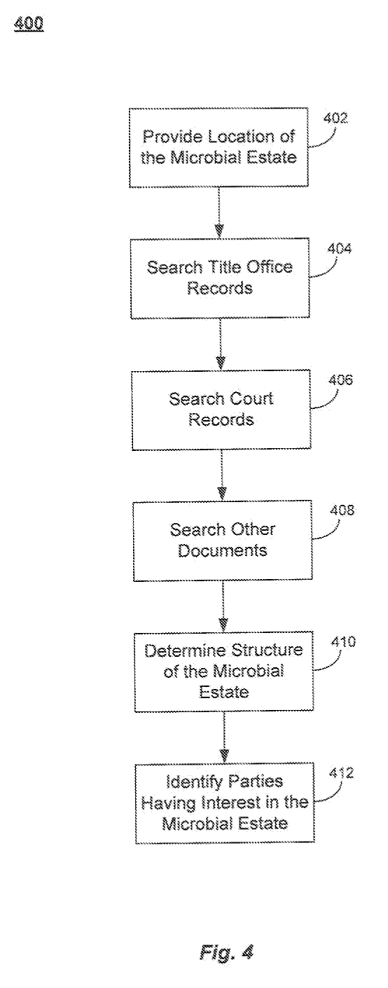

FIG. 3 shows a system 300 for searching and listing interests in microbial estates according to embodiments of the invention. The system 300 may use the public Internet 302 for communications between a searcher's communication device 304 (e.g., a computer, PDA, etc.) and a search engine host 306 that processes the search requests. The host 306 is in communication with a database 308 that stores information on microbial estates, allowing the host to retrieve information on the estates in response to search queries sent from the searcher. The searchable interests may include interests in the microbial estate that have been recorded in a clerk and recorders office in the county in which the parcel of land is situated, and may also include interests recorded in a federal office (e.g., the Bureau of Land Management Estate Office). The interests may further include leases, contracts, etc., in microbial estates that are listed in public and/or private databases, and which may or may not have also been recorded in a local, state and/or federal title recordation office. Search results retrieved by the host 306 may be sent over the Internet 302 to a results display 310 of the searcher (e.g., a computer monitor).

The search engine host 306 may include a web server (not shown) that allows a searcher to conduct a search using a web page displayed on a web browser that runs on the communication device 304. When necessary, the web server can format the data retrieved from database 308 for display on a web page shown on the results display 310.

Numerous permutations and variations of the above database structure 200 and system 300 for recording and searching information about microbial estates are also included in the invention. For example, the division of the database structure 200 into three tables may be replaced by a structure with a single table, two tables, or a structure with four or more tables. The placement of the fields in each table, and types of information stored in each field, may also be different from that shown in FIG. 2. Also, the search engine host 306 may communicate through the microbial rights database 308 through the Internet 302, instead of having a direct connection to the host 306. The single database 308 shown may be replaced by a plurality of databases, some of which may be in direct communication with host 306, while others communicate with the host 306 through the Internet 302. In addition, a private communication network may replace the public Internet 302 as the communication infrastructure for communications between device 304, search engine host 306 and database 308.

Electronic database systems like system 300, may be used by searchers (sometimes called landmen) to determine the parties that hold interests the microbial estate (as well as other estates) associated with a parcel of land. FIG. 4 shows a flowchart outlining the tasks 400 that a landman may undertake to determine the parties of interest in a microbial estate. These tasks 400 may include providing the landman with the location of the microbial estate 402, and having them travel to a local, state or federal clerk and recorder's office (e.g., a title office) to search the recorded abstracts and/or title documents for a parcel of land 404. Where the microbial estate may be involved in a judicial proceeding, the landman may also go to courthouses and/or court records offices 406 to search probate records, bankruptcy records, court judgments, settlement agreements, divorce records, etc. The landman may also try to locate other documents 408 that could give a party an interest in a microbial estate, including lease documents, bank loan agreements, joint operating agreements, farmout agreements, purchase and sale agreements, investment agreements, drilling contracts, stock and bond offering documents, etc. Once the landman has collected all the relevant documents he or she can find, he may be able to make a determination of the structure of the microbial estate 410, and identify the parties having interests in the microbial rights that make up the estate 412. Electronic record searches, when possible, may assist the landman in searching for records and documents about the microbial estate.

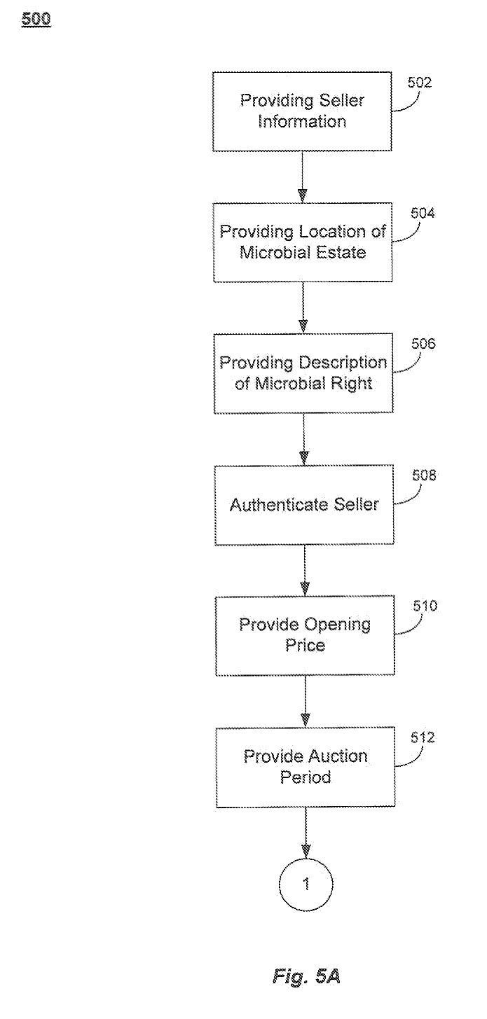

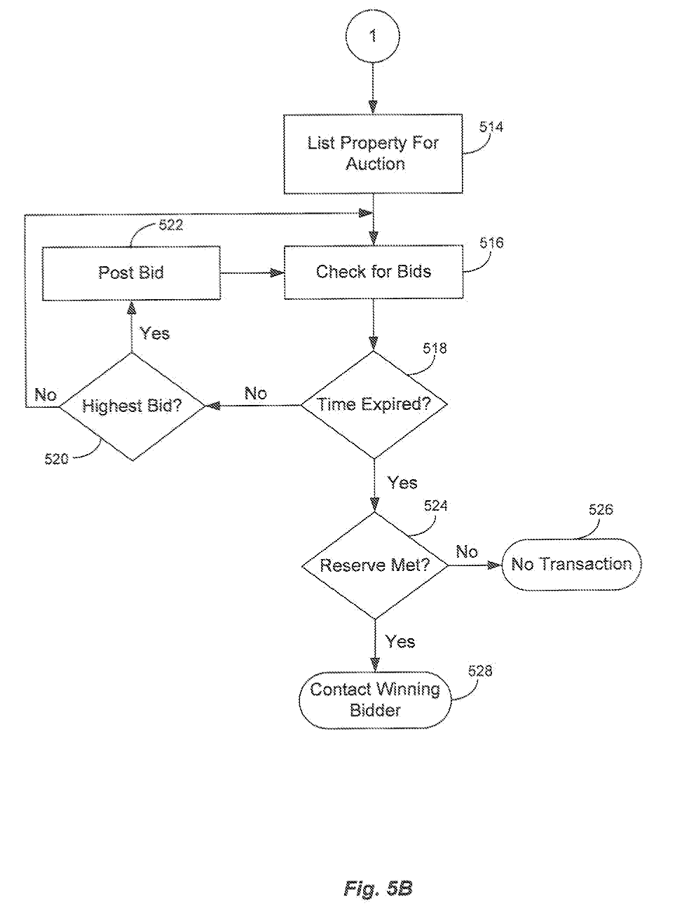

The ability to electronically search and list interests in microbial estates facilitates the creation of markets for transferring those interests between rights holders (i.e., sellers) and potential buyers. FIGS. 5A-B show a flowchart that outlines steps in a method 500 of auctioning microbial rights according to embodiments of the invention. The method 500 includes providing information about a seller (or lessor) 502 to the auctionplace. This information may include the sellers name, contact information, and number of previous auctions where the seller was a party. If the auctionplace is an electronic auction site, seller information may also include a unique handle used to identify the seller on the auction site, and the contact information may include an email address and/or a web address for the seller.

The seller can also provide information about the microbial estate and/or microbial rights to be auctioned. This information may include the parcel of land on which the microbial estate is located 504, and a description of the microbial rights that are going to be auctioned 506. For an electronic auction site, the seller may input this information manually, or download the information from a microbial rights database that has a description of the location of the microbial estate and the rights being auctioned.

Once the information is provided about the seller and the microbial rights being auctioned, authentication of the sellers interest in the microbial estate, and the seller's ability to transfer those rights, may be checked 508. Authentication 508 may include searching electronic search and recordation databases, as described above, to confirm the seller is a bona fide seller of the microbial rights being offered.

The seller provides an opening price 510 for the rights being auctioned, and the time period 512 in which bids will be accepted before the auction closes. The seller can also specify whether there is a reserve for the auction, and the threshold amount to meet the reserve. The seller may then list the offered property 514 for auction at the auction place (e.g., an electronic auction site) to start the auction. The auction may include a check for bids 516 for the offered property followed by a check to see whether the auction period has ended 518. If there is still time left in the auction, then a determination is made to see if any bids placed during the current cycle are higher than the current high bid for the property 520. If the highest of the new bids is higher than the current high bid, then the bid should be posted as the new high bid 522 for the auction. If none of the new bids exceed the current high bid, then a new cycle of checking for bids 516 may begin.

When the time period for the auction has expired, a determination may be made of whether the current high bid meets or exceeds the reserve threshold 524, for auctions that have a reserve. If the reserve has not been met, then the auction terminates without a transaction 526. When the reserve is met, the winning bidder is contacted 528 so that the transaction can be finalized.

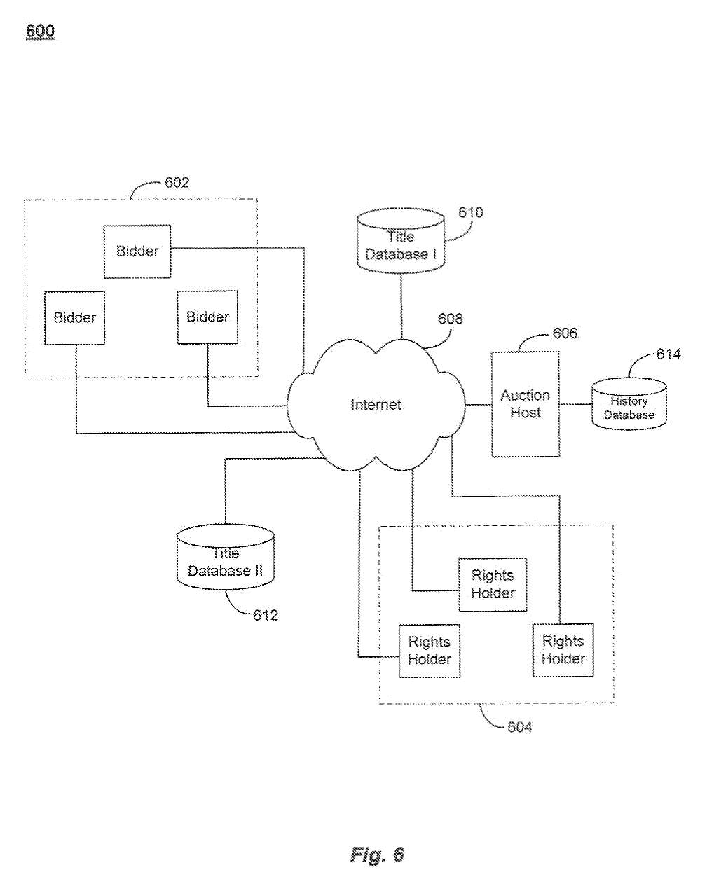

FIG. 6 shows an example of an electronic auction network 600 that may be used to implement electronically the auction method illustrated in FIG. 5. The network 600 includes bidder nodes 602 and rights holders nodes 604 that communicate with an auction host 606 through and electronic communications infrastructure, such as the Internet 608. The bidder nodes 602 and rights holders nodes 604 may include a computer or other type of network interface. The nodes 602 and 604 are defined by the activity of the network user at the node. Thus, when a user is bidding for a microbial right being auctioned, the node is one of the bidder nodes 602, while when that same user is posting a microbial right/estate for auction, the node is considered a rights holders node 604.

The auction host 608 can accept auction postings from rights holders inputting the postings at rights holder nodes 604. The host 608 may be equipped to post and run multiple auctions at the same time. When a rights holder sends auction information to the auction host 608, the host may communicate with one or more microbial estate databases 610 and 612 to confirm that the rights holder actually holds, and can transfer, the microbial right to be auctioned.

When an auction ends successfully, the auction host 608 may record information about the in an auction history database 614. The recorded information may include a description of the microbial property that was auctioned, the date of the auction close, the identity of the seller and wining bidder, and winning bid price, among other information. The auction host 608 may also record the transaction in one or more of the microbial estate databases 610 and 612. The transaction can be provisionally recorded by the auction host 608 at the close of a successful auction, and later confirmed, modified or stricken by the buyer and seller if the transaction is completed.

It should be appreciated that many variations of the above described method 500 and network 600 for auctioning interests in a microbial estates are also included in the invention. For example the auction described in method 500, sometimes referred to as an English or open-outcry auction, may be replaced by another one-sided auction method (i.e., an auction where only bids are permitted, but not “asks”) such as a Dutch auction, a first-price sealed bid auction, a Vickrey auction, etc. The invention may also include double-auction methods where bids and asks are permitted at the same time as in, for example, a stock or commodities exchange. Double auction methods may include Double Dutch auctions, and continuous double auctions, among other types of double auctions.

Moreover, variations on the network 600 may include a private network replacing the Internet 608 as the electronic communications infrastructure through which the bidder nodes 602, rights holder nodes 604, auction host 608 and microbial estates databases 610 and 612 communicate with one another. In addition, the auction host 608 and auction history database 614 may communicate with each other through the Internet 608.

By separating a microbial estate and its constituent microbial rights from other estates in the parcel of land, a market can be formed just for transactions involving microbial resources and uses associated with the parcel. In some embodiments, the microbial rights market may require a right to conform to predefined set of standards in order to be listed and/or traded in that market. The market may be used for trading both standardized and non-standard microbial rights and estates.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of auctioning a microbial right in microbial property, the method comprising:
posting, on an electronic trading system, an offer for a proprietary interest in the microbial right; and
soliciting one or more bids for the microbial right from bidders accessing the electronic trading system, wherein the bidder having a highest bid price acquires the proprietary interest in the microbial right.

2. The method of claim 1, wherein the microbial property comprises real property or personal property.

3. The method of claim 1, wherein the proprietary interest in the microbial right is ownership of one or more of microorganisms located on real property.

4. The method of claim 1, wherein the proprietary interest comprises permission to recover microorganisms from the real property.

5. The method of claim 1, wherein the electronic trading system is accessed through an internet website.

6. The method of claim 1, wherein the microbial right comprises ownership of a sample of microorganisms collected from the real property.

7. A method of electronically auctioning a microbial property right held by a seller, the method comprising:
providing property right information to an electronic auctioning system, wherein the property right information includes an identity of the seller and a description of the microbial property right;
authenticating that the seller currently holds title to the microbial property right;
posting on the electronic trading system an offer to sell the authenticated microbial property right; and
collecting one or more bids in the electronic auctioning system to buy the authenticated microbial property right.

8. The method of claim 7, wherein a highest price bid is accepted by the seller, who sells the microbial property right to a bidder making the highest priced bid.

9. The method of claim 7, wherein the identity of the seller comprises a name of the seller, an postal address of the seller, an email address of the seller, a web address of the seller, or a handle used to identify the seller in the electronic auctioning system.

10. The method of claim 7, wherein the method may further include searching an electronic database holding title information about microbial property rights to authenticate that the seller currently holds title to the microbial property right.

11. The method of claim 7, wherein the seller provides an opening bid price for the microbial property right.

12. The method of claim 7, wherein the seller provides a reserve threshold price for the microbial property right.

13. The method of claim 7, wherein the electronic auctioning system provides new ownership information about the microbial property right to an electronic database holding title information about microbial property rights.

14. A method of electronically trading a microbial right in a microbial property, the method comprising:
posting on an electronic trading system a bid for a proprietary interest in the microbial right, wherein the bid includes a first price to buy the proprietary interest; and
posting a response from a microbial rights holder, wherein the response comprises a notice of acceptance of the bid or a counter-offer that includes a second price different than the first price.

15. The method of claim 15, wherein the second price is higher than the first price.

16. The method of claim 15, wherein the proprietary interest in the microbial right is ownership of one or more of microorganisms located on real property.

17. The method of claim 15, wherein the proprietary interest comprises permission to recover microorganisms from the real property.

18. The method of claim 15, wherein the microbial right comprises ownership of a sample of microorganisms collected from the real property.
